(19) United States
(12) Patent Application Publication
(10) Pub. No.: US 2025/0074704 A1
(43) Pub. Date: Mar. 6, 2025

(54) SYSTEM AND METHOD FOR MITIGATING ORDER PICKING BOTTLENECKS

(71) Applicant: Dematic Corp., Grand Rapids, MI (US)

(72) Inventors: Martin E. Schubilske, Brookfield, WI (US); Jeffrey M. Jacobs, Wauwatosa, WI (US)

(21) Appl. No.: 18/819,468

(22) Filed: Aug. 29, 2024

Related U.S. Application Data
(60) Provisional application No. 63/579,702, filed on Aug. 30, 2023.

(51) Int. Cl. B65G 1/137; G06Q 10/087

(52) U.S. Cl. CPC B65G 1/1378; B65G 1/1371; G06Q 10/087; B65G 2209/02; B65G 2209/10

(57) ABSTRACT

A system having a process for order fulfillment bottleneck mitigation that includes receiving, at a picking station, a first tote specific to a first order with the first tote containing items specific to the first order and a plurality of other orders. A first quantity of items required by the first order are retrieved along with a second quantity of items that is the sum of the items required by the other orders. The second quantity of items are stored in a storage at the picking station. A second tote is received at the first picking station that has no further orders pending. A third quantity of items required by a second order is retrieved from the storage and placed into the second tote.

### CROSS REFERENCE TO RELATED APPLICATION

The present application claims benefit of U.S. provisional application Ser. No. 63/579,702 filed Aug. 30, 2023, which is hereby incorporated herein by reference in its entirety.

### FIELD OF THE INVENTION

The present invention is directed to warehouse automation and, in particular, to movement of inventory/material throughout a warehouse.

### BACKGROUND OF THE INVENTION

E-commerce retail and changing demand patterns are driving increased variation in the types and formats of products (e.g., single-count versus multi-count) handled in goods distribution centers. Distribution centers not only need to deal with increased product variety, but also volatile and unpredictable shifts in demand patterns which are typically mitigated by buffer storage of a large variety of unit categories. At the same time, storage space is at a premium, with distribution center owners growing or consolidating distribution centers and striving for increased storage density. With increased storage density and an increased variety of unit categories, congestion is also increasing, with an increased incident of bottlenecks from delayed access to desired unit categories.

### SUMMARY OF THE INVENTION

The present invention provides an automated warehouse material handling and movement system, methods, and non-transitory computer-readable medium for handling or moving material within a warehouse or material handling facility. The system, methods, and non-transitory computer-readable medium include a process for picking goods at a picking station for the purpose of order fulfillment, in which units are picked from donor totes at picking stations and placed into order totes. The system and method include goods picking situations where the order totes require articles from more than one category in order for orders to be fulfilled (i.e., mixed SKU picking) and a process for ensuring that articles that are required in small amounts for several orders concurrently (“golden SKUs”) and the totes holding these articles (“golden totes”) do not become bottlenecks in the picking process.

In an aspect of the present invention, an exemplary method includes receiving a donor tote (i.e., the golden tote) with bottleneck SKU units (a golden SKU) at a picking station. After the required quantity of bottleneck or golden SKU units are retrieved from the golden tote for the current order, the picking station is directed to retrieve an additional quantity of bottleneck SKU units equal to the number of bottleneck SKU units required to fill a selected quantity of orders requiring the bottleneck SKU units. The additional quantity of bottleneck SKU units are placed into a “set-aside cubby” at the picking station. Thereafter, the “set-aside” bottleneck SKU inventory is opportunistically distributed by being added to other donor totes that come to the pick station and would thereafter be returned to a storage area as they have no additional picking tasks remaining. Such creates donor totes with mixed inventory SKU units. That is, when there are no remaining orders to be fulfilled from a donor tote, a portion of the bottleneck SKU inventory is placed into the tote. Any pick station can then access the bottleneck SKU inventory in the newly created donor totes (with multi-SKUs) as well as the original donor tote with the bottleneck SKU inventory. By repeating this process step, there will be no remaining “golden totes.” Instead, there will be multi-SKU totes containing the previous bottleneck golden SKU units along with the original or “primary” SKU inventory for that tote.

In an aspect of the present invention, an exemplary material handling system has a process for order fulfillment bottleneck mitigation that includes receiving, at a picking station, a first donor tote specific to a first order with the first donor tote containing first items specific to a first order and a plurality of other orders. A first quantity of first items specific to the first order are retrieved along with a second quantity of first items that is the sum of the quantities of the first items required by a selected quantity of other orders. The second quantity of first items are stored in a temporary storage at the picking station. A second donor tote is received at the first picking station that has no further orders pending. A third quantity of first items is retrieved from the temporary storage and placed into the second donor tote. The third quantity is the quantity of first items required by a second order of the selected quantity of other orders.

In another aspect of the present invention, an exemplary material handling system for retrieving, transporting, and delivering donor totes for order fulfillment activities within a material handling facility includes a plurality of picking stations, a storage area, and a control system. The picking stations are each configured for picking operations as part of order fulfillment activities in the material handling facility. The storage area is configured for storing inventory totes, each comprising one or more associated inventory items. The control system is for controlling the order fulfillment activities within the material handling facility and for identifying an inventory tote as a multi-order tote containing inventory items required by a plurality of orders. A first picking station of the plurality of picking stations is configured for receiving a first order and requesting a first inventory tote comprising a plurality of first inventory items required by the first order that are also required by one or more additional orders. The first picking station is configured to retrieve a quantity of first inventory items from the first inventory tote as required by the first order. The first picking station is configured to retrieve a second quantity of first inventory items from the first inventory tote as defined by the control system. The second quantity of first inventory items is the sum of the quantities of first inventory items required by selected orders of the one or more additional orders. The first picking station includes a first cubby configured to hold the second quantity of first inventory items. The first picking station is configured to receive and process additional inventory totes comprising additional inventory items required by the first order. The first picking station is configured to retrieve a third quantity of first inventory items from the first cubby and place them into a selected second inventory tote of the additional inventory totes that does not have any remaining orders to fulfill. The third quantity of first inventory items is the quantity of first inventory items required by a second order of the one or more additional orders.

In an aspect of the present invention, the exemplary method comprises a non-transitory computer-readable medium including one or more instructions which, if executed by a controller, cause the controller to perform the steps to the exemplary method comprising, after receiving a donor tote with bottleneck SKU units at a picking station and removing a required quantity of bottleneck SKU units from the donor tote for the current tote, directing the picking station to retrieve an additional quantity of bottleneck SKU units equal to a number of bottleneck SKU units required to fulfill all the remaining orders requiring the bottleneck SKU units. These other bottleneck SKU units are placed into a “set-aside cubby” at the picking station. The “set-aside” bottleneck SKU inventory is opportunistically distributed by adding selected quantities of units of the bottleneck SKU inventory to other donor totes that come to the pick station. Adding the quantities of bottleneck SKU inventory units to the other donor totes converts the other donor totes into mixed inventory donor totes with mixed inventory SKU units. Thereafter, any pick station requiring the bottleneck SKU inventory units can access the bottleneck SKU inventory in the mixed inventory donor totes as well as the original donor tote with the bottleneck SKU inventory.

In a further aspect of the present invention, the first picking station performing the opportunistic distribution updates the control system as to the identity of the second inventory tote, selected to receive inventory items from the first cubby, and its new association with the second order. The control system is configured to direct the second inventory tote to a second picking station when the second picking station starts fulfilling the second order.

In another aspect of the present invention, the control system is configured to direct the second inventory tote to the storage area to temporarily store the second inventory tote until a picking station starts fulfilling the second order and requires the first inventory items in the second inventory tote.

In a further aspect of the present invention, the second inventory tote contains two different inventory items (SKUs) when the first inventory items are added to the second inventory tote.

In another aspect of the present invention, the second inventory tote is configured as an unsegmented tote such that the two different inventory items are comingled.

In yet another aspect of the present invention, the second inventory tote is configured as a segmented tote such that the first inventory items are segregated from the inventory items already stored in the second inventory tote.

In another aspect of the present invention, the material handling system includes autonomous mobile robots (AMRs) configured for retrieving inventory totes from the storage area and delivering the retrieved inventory totes to selected picking stations order fulfillment activities. Alternatively, the material handling system includes retrieval means and transportation means that include human worker interaction and/or are performed by human workers. In yet another alternative, the material handling system includes a combination of any of automated guided vehicles (AGV), AMRs, remote-controlled devices/vehicles, human workers, and human worker-controlled retrieval/transportation devices.

The present invention thus provides methods, systems, and non-transitory computer-readable medium for picking goods at a picking station for the purpose of order fulfillment, in which units are picked from donor totes at picking stations into order totes. The method specifically applies to a goods picking situation where the order totes require articles from more than one category (SKU) in order for orders to be fulfilled (mixed SKU picking), and a method for ensuring that articles (SKUs) that are required in small amounts for several orders concurrently (“golden SKUs”) and the totes holding these articles (“golden totes”), do not become bottlenecks in the picking process.

These and other objects, advantages, purposes, and features of this invention will become apparent upon review of the following specification in conjunction with the drawings.

### BRIEF DESCRIPTION OF THE DRAWINGS

FIG. 1 is a block diagram illustrating the operational and control components of an exemplary order fulfillment system;

FIG. 2 is a block diagram of an exemplary aspect of a fulfillment/warehouse facility employing the control system in accordance with the present invention;

FIGS. 3A and 3B illustrate the steps to a method for mitigating requested tote bottlenecks arising from mixed unit picking in accordance with the present invention;

FIG. 4A illustrates an exemplary donor tote (i.e., a golden tote) containing a bottleneck SKU in accordance with the present invention;

FIG. 4B illustrates an exemplary set-aside cubby at a picking station and containing additional units for one or more bottleneck SKUs in accordance with the present invention;

FIG. 5A illustrates the set-aside cubby of FIG. 4B with the additional bottleneck SKU units separated into plastic bags in accordance with the present invention;

FIGS. 5B and 5C illustrate exemplary donor totes, each containing a quantity of bottleneck SKU units which are mixed with the donor tote's original SKU units to form a multi-SKU donor tote in accordance with the present invention;

FIG. 6 is a block diagram of an exemplary warehouse environment employing an exemplary process for moving donor totes to requesting picking stations while mitigating order fulfillment bottlenecks caused by donor totes with inventory units simultaneously requested at multiple picking stations in accordance with the present invention; and

FIG. 7 is a block diagram of exemplary segmented donor totes and unsegmented donor totes in accordance with the present invention.

### DESCRIPTION OF THE PREFERRED EMBODIMENTS

The present invention will now be described with reference to the accompanying figures, wherein numbered elements in the following written description correspond to like-numbered elements in the figures. Due to the increasing variation in the types and formats of products (e.g., single-count versus multi-count of inventory units) handled in distribution centers, order fulfillment in such distribution centers or warehouses needs to deal with an increased product variety as well as other related complications. A typical means for dealing with such an increasing variety of products is to store sufficient quantities of each unique inventory unit (units that are identified or represented by a unique stock keeping unit “SKU”) in a warehouse. Such units are stored in totes referred to as “donor totes.” However, such facilities are also growing in size and complexity and striving to increase storage densities. Due to the increase in the number and variety of inventory units (or SKUs) requiring order fulfillment, such order fulfillment may temporarily, or over longer periods of time become dependent on specific unit categories, such as popular SKUs that are needed in several orders concurrently at different pick stations (and thus creating a “bottleneck” in the order fulfillment activities of the other pick stations). An exemplary bottleneck SKU is an inventory unit SKU that is needed in a quantity of order above a threshold concurrently. For example, in one embodiment, the threshold quantity is more than one (1) additional order. That is, if an inventory unit SKU was needed for two or more orders, it would be considered a bottleneck SKU. When a donor tote with units having a SKU belonging to one of these bottleneck inventory categories (this inventory item is considered a “golden SKU”) is being processed at one picking station, several other picking stations are stalled as they wait for the same donor tote (considered a “golden tote”) with the desired SKUs to become available (or be released). Merely increasing the quantity of donor totes holding the bottleneck SKU units can be difficult to store in the storage areas of a warehouse as adding additional donor totes for the same quantity of inventory reduces the storage density in the warehouse. Thus, there is a need for an order fulfillment process and system that can mitigate the order fulfillment bottlenecks arising in mixed SKU picking that does not reduce storage density in the storage areas and can be flexibly applied to any unit category (or SKU) that becomes a bottleneck at a given time. As discussed herein, an exemplary solution provides for the opportunistic creation of multi-SKU donor totes out of single-SKU donor totes at a picking station that were ready to return to the storage area. Each of the multi-SKU donor totes are opportunistically provided with a quantity of a bottleneck SKU from its corresponding golden tote such that the order fulfillment bottleneck (for that inventory SKU) can be mitigated. Alternatively, a non-bottleneck donor tote that receives a quantity of a bottleneck SKU (to become a multi-SKU donor tote) may be any donor tote that has completed a current order fulfillment operation at a picking station and the quantity of remaining orders in the order queue of that non-bottleneck donor tote is below a threshold (e.g., less than one order remaining). That is, a multi-SKU donor tote can be opportunistically created out of any non-bottleneck donor tote with an order queue below the threshold. While the example of less than one (1) order remaining, i.e., no (0) orders remaining, has been used, the threshold value could be any desired quantity, e.g., no more than one (1) or two (2) orders remaining. The threshold could be any number, depending on order fulfillment circumstances.

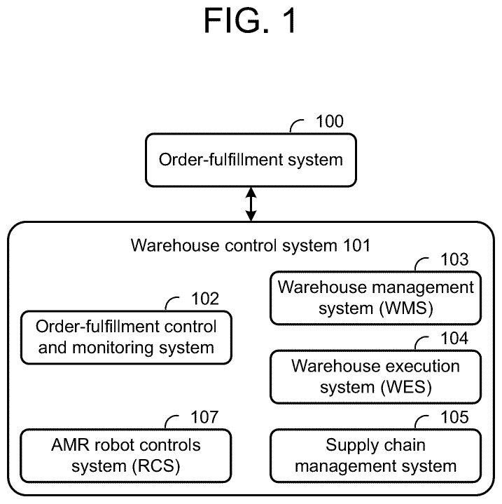

FIG. 1 illustrates an exemplary warehouse environment or aspects thereof in which order fulfillment activities are taking place. It should be appreciated that the order fulfillment systems employing control systems in accordance with the present invention may be configured and employed in numerous ways and environments utilizing variously configured and differing material storage and handling systems. Accordingly, the below discussion of FIG. 1 should be understood as non-limiting and provided for explanatory purposes.

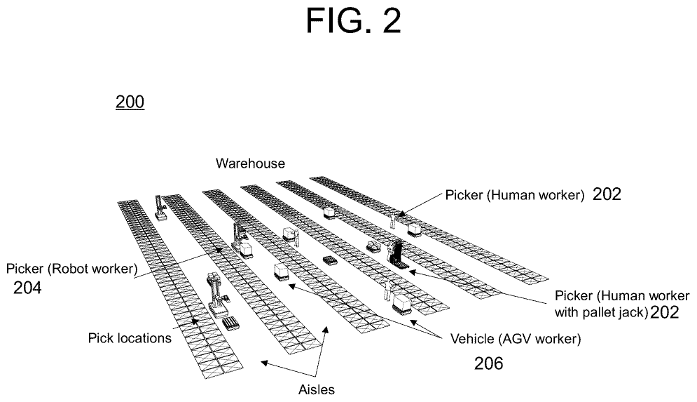

Referring to FIGS. 1 and 2, an exemplary order fulfillment system 100 includes a warehouse controller or orchestrator (a warehouse control system) 101, which can be coupled to or include a fulfillment control and monitoring system 102, a warehouse management system (WMS) 103, a warehouse execution system (WES) 104, and a supply chain management system 105. As illustrated in FIG. 1, the control of automated equipment in the warehouse may be controlled in conjunction with or cooperation with an AMR robot controls system (RCS) 107. FIG. 2 illustrates an exemplary warehouse or storage facility 200 for order fulfillment, which is disclosed for use with control systems, e.g., the order fulfillment system 100 and associated warehouse control system 101, in accordance with aspects of the present invention. An exemplary warehouse environment 200 includes a variety of different agents 202, 204, 206. Each class of agents has distinct objectives and capabilities. The agents illustrated in FIG. 1 include human pickers 202, robotic pickers (also referred to as retrieval/putaway autonomous mobile robots (AMRs) (“retrieval/putaway AMRs”) 204, and automated guided vehicles (AGVs) or AMRs configured for transportation (“transport AMRs”) 206, configured to carry items picked by the human pickers 202 and/or the retrieval/putaway AMRs pickers 204. The overall logistics of the warehouse 200 would be distributed across the classes of agents 202, 204, 206. The retrieval/putaway and transportation agents 204, 206 may alternatively be implemented with remote-controlled devices/vehicles, human workers, and/or human worker-controlled retrieval/putaway and transportation devices. Additional agents would include fixed automation assets in the warehouse 200 as well as fulfillment management systems (e.g., WES, WCS, and WMS). The agents 202, 204, 206 are allocated and/or assigned to one or more order channels within the warehouse 200, which are managed by the order fulfillment system 100 and the warehouse control system 101. As discussed herein, the order-fulfillment system 100, the warehouse control system 101, and the order-fulfillment control and monitoring system 102 will adjust the order fulfillment activities in the warehouse 200 to mitigate the effect of bottlenecked SKU units.

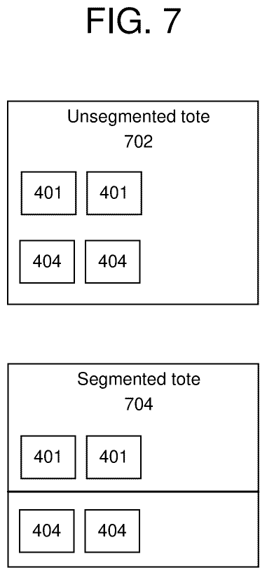

As illustrated in FIGS. 2 and 6, exemplary AMR vehicles 204, 206 may be used to retrieve and deliver donor totes 160 to picking stations 604 for order fulfillment. As discussed herein, use of AMR vehicles 204, 206 is understood to be exemplary only, as other means or devices may also be utilized for retrieving and delivering the donor totes 160 to the picking stations 604 for order fulfillment. The warehouse 200 may include one or more storage areas 602 configured for high density storage of inventory units (SKUs) contained in donor totes 160. Referring to FIG. 6, at least one SKU is considered to be a bottleneck SKU as it is needed at more than one picking station 604 (as noted herein, a bottleneck SKU is an inventory item SKU that is needed concurrently in a quantity of orders above a threshold, e.g., one additional order). For example, donor tote 160G contains a bottleneck SKU and is therefore called a “golden tote” 160G. Similarly, the bottleneck SKU is referred to as a “golden SKU.” Each picking station 604 of FIG. 6 includes an order tote 162, into which required inventory items or SKUs for an order are placed. These SKUs are retrieved from donor totes 160 that have been retrieved from storage area 602 and delivered to the requesting picking station 604. Note that generally, each donor tote 160 contains a unique inventory unit SKU (except in segmented totes which can contain multiple SKUs) (see FIG. 7). As illustrated in FIG. 6, both picking stations 604a and 604b require the golden tote 160G to complete an order, such that once the golden tote 160G is retrieved by a retrieval/putaway AMR 204 and delivered by a transport AMR 206 to the picking station 604a (for order fulfillment), the other picking station 604b will have to wait until the bottlenecked SKU is available for order fulfillment at the waiting picking station 604b. As discussed above, while FIG. 6 illustrates the store areas 602 and the picking stations 604 as serviced by AMRs 204, 206, other means for donor tote retrieval and delivery to the picking station 604 could be utilized. For example, in one embodiment the requested donor totes 160 could be manually delivered by workers 202 in the warehouse 200 (e.g., on foot or operating/driving suitable equipment for human worker facilitated retrieval/putaway and delivery of donor totes 160). That is, the retrieval and delivery of donor totes 160 (from storage areas 602 to picking stations 604) is not restricted to just AMR retrieval and delivery.

It is generally not feasible to mitigate the resulting order fulfillment bottleneck by storing inventory units of bottleneck categories (i.e., the golden SKUs) in multiple donor totes for several reasons. As discussed herein, if the inventory units or “SKUs” from bottleneck categories (i.e., golden SKUs) are stored in multiple donor totes 160 in multiple storage locations within the storage area 602, when a single donor tote 160 (or a smaller quantity of donor totes 160) would have sufficed, storage in the storage area 602 would be less dense and less optimally planning, leading to reduced profitability (because more storage space is needed for a given quantity of inventory items). For another reason, if inventory units from bottleneck categories are stored together with other unit categories (multi-SKU totes), a system for tracking and handling these mixed storage units would be required, which would be costly and difficult. Furthermore, in a fast-paced order fulfillment environment, the actual unit categories that are bottleneck categories will shift, often on a daily basis, and thus, it may be difficult to predict how and where in the order fulfillment process that the above conventional mitigation methods could be successfully applied.

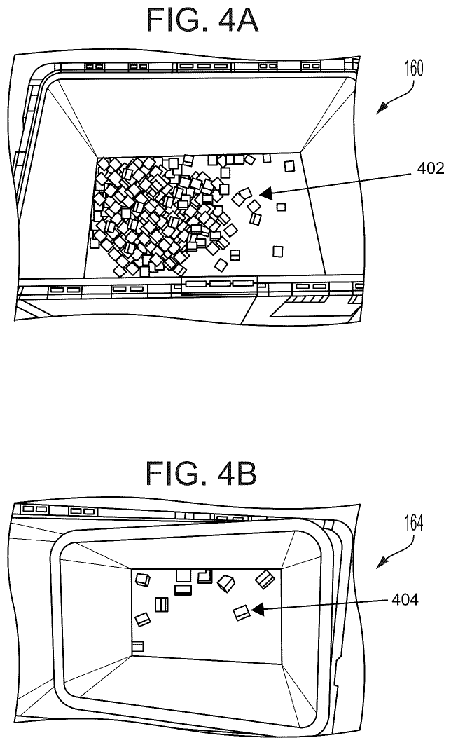

The exemplary method for mitigating order fulfillment bottleneck categories avoids these difficulties by not reducing storage density and can be flexibly applied to any inventory unit category that becomes an order fulfillment bottleneck and at any time. As described herein, the exemplary mitigation method can be implemented in systems where orders are picked by human or robot order pickers at order stations 604. Referring to FIGS. 4-6, by preparing an order list of expected orders to be fulfilled during a given period of time, those donor totes 160 with SKUs (i.e., inventory units/items) that are needed to fulfill more than one order during that given period of time are identified. Because the inventory units in these donor totes 160 will be needed to fulfill more than one order, these SKU units are expected to create order fulfillment bottlenecks (i.e., “bottleneck SKUs” or “golden SKUs”). These donor totes 160 with golden or bottleneck SKUs are also referred to as golden totes (e.g., golden tote 160G in FIG. 6). Once the bottleneck SKUs have been identified, those orders requiring the bottleneck SKUs will be given priority in the order fulfillment queue.

Thus, once the first order with a bottleneck SKU has been selected for fulfillment, the required golden tote (e.g., golden tote 160G) will be retrieved by an AMR 204 or by a human worker 202 (either directly retrieving or operating/controlling a retrieval device) from the storage area 602. The retrieved golden tote 160G will be delivered (via transport AMR 206 or human operated (or directed) transport) to the requesting picking station (e.g., picking station 604a). A robot picker or human picker at the picking station 604a will remove from the golden tote 160G the required quantity of SKU units necessary to fulfill the order (for the golden SKU) currently being fulfilled at the picking station 604a. Next, the picking station 604a will pick an additional quantity of the golden SKU units from the golden tote 160G. This additional quantity of golden SKU units (equal to the total quantity of golden SKU units needed to fulfill all orders for the given period of time, or some other selected quantity of golden SKU units) is placed into a “set-aside cubby” 164 at the picking station 604a. In other words, some quantity of golden SKU units may be left in the golden tote 160G such that the golden tote 160G is available to send to another picking station 604.

Thereafter, the golden tote 160G can be returned to the storage area 602 or sent on to a next picking station 604 (e.g., picking station 604b) for order fulfillment. When a next donor tote 160 arrives for order fulfillment at the picking station 604a, it is anticipated that this donor tote (e.g., donor tote 160a) will be a single-SKU order donor tote 160a (or alternatively a segmented tote 160) with a limited number of orders needing the particular SKU contained in the donor tote 160a (e.g., no orders remaining or less than “X” orders remaining or predicted in the totes). After the required SKU units are removed from the donor tote 160a, the donor tote 160a will not be needed at another picking station 604 and may be returned to the storage area 602. It is at this time that the picking station 604a acts opportunistically to distribute the golden SKU units that have been temporarily stored in the set-aside cubby 164. Rather than returning the donor tote 160a to the storage area 602, a quantity of the golden SKU units set aside in the set-aside cubby 164 will be placed into the donor tote 160a. While this turns the donor tote 160a into a multi-SKU donor tote 160a, only one of the inventory SKUs contained within will be needed for the remaining order fulfillment activities (i.e., the golden SKU units). At this time the picking station 604a will update the order fulfillment records at the order fulfillment system 100 and/or warehouse control system 101 with respect to the golden SKU units that have been placed into the multi-SKU donor tote 160a. For example, when the quantity of golden SKU units placed into the multi-SKU donor tote 160a are associated with a particular yet to be fulfilled fulfillment order, the order will be updated as to the location of the associated inventory items (i.e., the golden SKU units for that order and the location of multi-SKU donor tote 160a).

When a quantity of gold SKU units have been retrieved from the set-aside cubby 164 and placed into a multi-SKU donor tote (e.g., donor tote 160a), the order requiring that quantity (or portion) of golden SKU units is then released for order fulfillment. With the next order released that is requiring the golden SKU, the multi-SKU donor tote 160a may then be sent to an optional next picking station (e.g. picking station 604b) for order fulfillment. That is, picking station 604b has received an order requiring a quantity of the golden SKU units. Alternatively, the “next” picking station may be the current picking station (e.g., picking station 604a). Likewise, when a next donor tote (e.g., donor tote 160b) has completed its last order fulfillment at the picking station 604a, the donor tote 160b can be used to receive a quantity of the golden SKU units stored in the set-aside cubby 164 (for the next order, or orders, or predicted orders). The multi-SKU donor tote 160b may then leave the picking station 604a and proceed to any picking station as a “next” picking station (e.g., picking station 604n with an order requiring the golden SKU units). Note that the donor totes 160G, 160a, and 160b may be transported from picking station 164 to picking station 164 (and back to the storage area 602) via transport AMRs 206 or human operated transports. In one embodiment, the selected quantity of golden SKU units that are placed into a donor tote 160 selected for opportunistic distribution can be equal to the quantity of golden SKU units needed to complete one order requiring the golden SKU units (thus, the multi-SKU tote (e.g., donor totes 160a, 160b) is not needed at multiple picking stations 604). Each donor tote (e.g., donor totes 160a, 160b) opportunistically filled with golden SKU units receives a quantity of golden SKU units equal to the quantity required by an associated order. That is, each donor tote (i.e., each multi-SKU donor tote 160a, 160b) reaches a quantity of golden SKU units that are assigned to a specific order for order fulfillment. Alternatively, rather than a quantity assigned, the quantity of golden SKU units can be a quantity for two (2) orders, a single order, and an additional quantity for a predicted order. While each multi-SKU donor tote 160a, 160b receiving an allotment of the golden SKU units from the set-aside cubby 164 has received golden SKU units for a particular order, if the order has not yet been released and/or the assigned picking station 604 has not yet requested the golden SKU units, the multi-SKU donor tote 160a, 160b can be returned to storage area 602 until requested by the picking station 604 (as determined by, for example, the warehouse control system 101 (see FIG. 1)).

The golden SKU units temporarily stored in the set-aside cubby 164 are opportunistically distributed to other donor totes 160 (e.g., donor totes 160 that have completed their respective assigned order fulfillment activities) until all of the golden SKU units stored in the set-aside cubby 164 have been distributed. Thereafter, with all the golden SKU units distributed from the set-aside cubby 164, the remaining orders requiring the golden SKU units will no longer be in contention for the golden SKU units as they have been distributed to other donor totes (e.g., donor totes 160a, 160b). To make the identification of the golden SKU units easier to identify in the multi-SKU tote (e.g., donor totes 160a, 160b), the distributed golden SKU units may be placed into bags, tied together with cording, or placed into a conspicuous location or segregated in some way from the original inventory item/unit SKU units in the donor totes 160a, 160b. That is, the gold SKU units can be readily identified from the other SKU units contained in the donor totes 160a, 160b.

In one embodiment, an additional quantity of the golden SKU units can be retained in the set-aside cubby 164 such that the picking station 604a may be used to fulfill another order requiring the golden SKU units. For example, the additional quantity of golden SKU units retained in the set-aside cubby 164 is not distributed into other donor totes (e.g., the multi-SKU donor totes 160a, 160b) for delivery to other picking stations (e.g., picking stations 604b, 604n). Instead, the golden SKU units are used for order fulfillment at the picking station 604a.

Note that while the method for opportunistically distributing golden SKU units from a set-aside cubby 164 is illustrated for a single golden tote 160G, any number of golden totes 160G with their associated golden SKU units may be processed and distributed (using one or more picking stations 604 to process and opportunistically distribute the golden SKU units). In one embodiment, one or more set-aside cubbies 164 are used for storing golden SKU units for each associated golden tote 160G (i.e., a picking station 604 may have one or more set-aside cubbies 164). In another embodiment, each picking station 604 can be configured to serve as a distribution point for only one respective golden tote (and its golden SKU units) at a time (see FIG. 6). That is, a next golden tote 160G will not be sent to picking station 604a until the last of the golden SKU units stored in the set-aside cubby 164 (of picking station 604a) have been distributed (resulting in the creation of multi-SKU donor totes (e.g., donor totes 160a, 160b), each with its allotted quantity of SKU units). In another embodiment one or more golden totes 160G will be sent to a same picking station 604, with respective golden SKU units from each of the one or more golden totes 160G placed into respective set-aside cubbies 164 of the picking station (e.g., picking station 604b). In another embodiment, all the golden SKU units may be placed into a single set-aside cubby, but placed into a separate bag, banded together, or segregated away from each other (i.e., the set-aside cubby 164 is configured as a “multi-SKU” set-aside cubby 164). That is, similar techniques can be used for easily separating the different sets of golden SKU units from each other for case of distribution in set-aside cubbies 164 as used in donor totes 160.

The donor totes 160 discussed so far have been unsegmented donor totes, such that the two different SKU units of the multi-SKU donor totes 160a, 160b can be comingled (while still able to use the discussed methods for distinguishing or separating the different SKUs in the multi-SKU donor totes 160a, 160b). In another embodiment, the donor totes 160 can be segmented, such that the two different SKU units of the multi-SKU donor totes 160a, 160b can be segregated into different compartments of the segmented donor totes 160 (see FIG. 7).

Referring to FIG. 1, the warehouse control system 101 includes or interfaces with a supply chain management system 105. Such a connection to the supply chain management system 105 allows for the distribution of inventory items across a network of multiple warehouses 200 for order fulfillment. For example, considering a warehouse 200 (or its storage area(s) 602) as individual totes, and with the supply chain management system 105 having access to all the totes (i.e., storage areas and/or warehouses), the supply chain management system 105 can management the order fulfillment activities of the network of warehouses 200, such that congestion of an entire warehouse 200 could be eliminated by transferring inventory items (with high demand) across multiple warehouses 200 in the network.

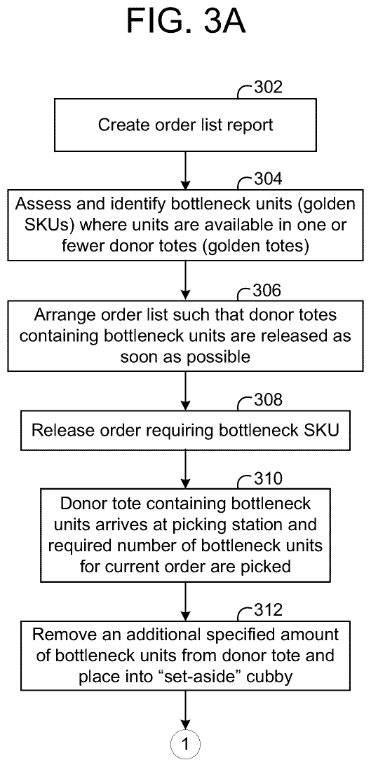

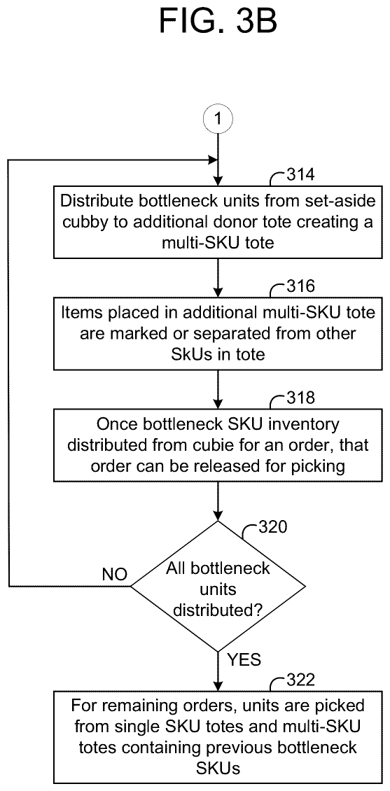

Referring to FIGS. 3A and 3B, an exemplary method for mitigating order fulfillment bottlenecks overcomes many of the difficulties of conventional methods for mitigating such bottlenecks while avoiding the normal storage density reductions and avoiding the additional decanting complexities. The method can be flexibly applied to any inventory unit SKU that becomes an order fulfillment bottleneck and at any time. The exemplary method begins in step 302 of FIG. 3A where an order list report is created. The report will include a list of orders that are to be fulfilled over a given period of time (e.g., a work shift or a current order backlog). In step 304 of FIG. 3A each of the listed orders are assessed to determine if any of the inventory units (SKUs) to be picked will be needed in quantities of orders above a threshold that will make it a bottleneck SKU (e.g., SKU requirements where there is more than one (1) order per donor tote 160 on average, such that while the donor tote 160 has been received at a first picking station for order fulfillment, a second (or more) picking station will be stalled, waiting for the donor tote 160). While an exemplary “more than one (1) order per donor tote” is illustrated, a different criterion could be used, e.g., “more than three (3) orders per donor tote.” In one embodiment, the assessment can be done with dynamic or non-dynamic rules based on order history, order forecasts, and supply chain information. The parameters for this assessment can be adjusted for the context of the picking situation, and can take into account the storage position of the inventory units (SKUs), the quantities of units required and quantities of orders requiring the inventory units, and the duration that an order picker can remain idle waiting for a needed inventory unit before the inventory unit should be considered a “bottleneck unit” or “golden SKU.” This assessment may take into account available real-world data on the history of orders processed in the specific context, may dynamically adjust in real-time based on picking data, or may be statistically set and manually be carried out at the beginning of each given shift. As discussed herein, the assessment of whether an inventory unit SKU is considered a bottleneck SKU can also be determined based upon the quantity of orders concurrently requiring the inventory unit SKU and whether that quantity is above a threshold quantity of pending orders (e.g., more than one (1) additional orders). Obviously, the quantity could be set to other quantities (e.g., two (2) or three (3) orders) depending on order fulfillment circumstances and particular inventory unit circumstances.

In step 306 of FIG. 3A, once the bottleneck categories (SKUs) or golden SKUs have been identified, the order list for the given time period (e.g., a day or shift) may be arranged so that orders requiring one or more units of a bottleneck category (i.e., golden SKUs) are assigned for fulfillment as soon as possible, early on in the time period. Once the orders have been arranged in step 306 of FIG. 3A, the orders are ready for release. In step 308 of FIG. 3A, a first order is released that includes a bottleneck SKU. In step 310 of FIG. 3A, a donor tote containing bottleneck SKU units (e.g., a golden tote 160G containing golden SKU units) arrives at the first picking station (e.g., picking station 604a) and the order picker at the picking station 604a retrieves the required quantity of bottleneck SKU units from the donor tote 160G to complete the order, and places the retrieved bottleneck SKU units into the order tote 162. FIG. 4A illustrates an exemplary donor tote 160 containing inventory items 402 of a particular SKU. That is, the donor tote 160 containing inventory items 402 in FIG. 4A may also be a golden tote 160G containing bottleneck SKUs or “golden SKUs.”

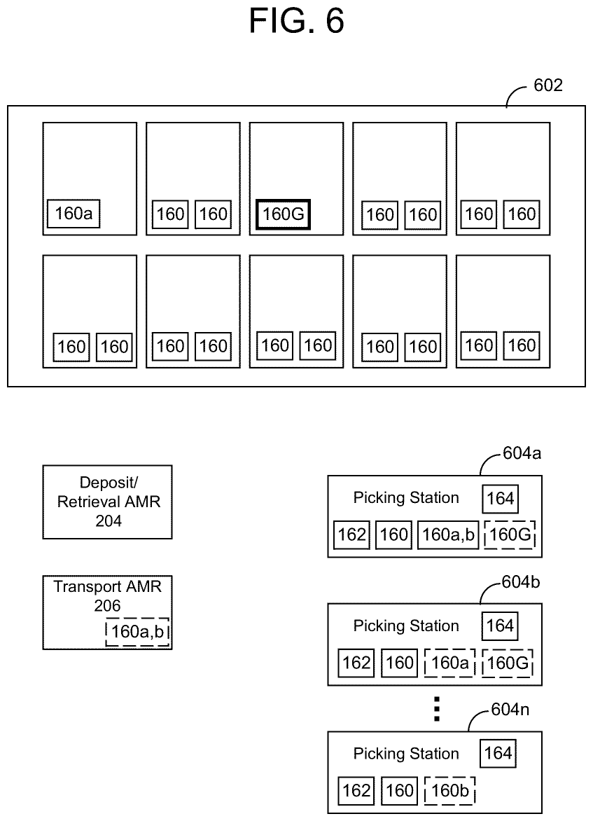

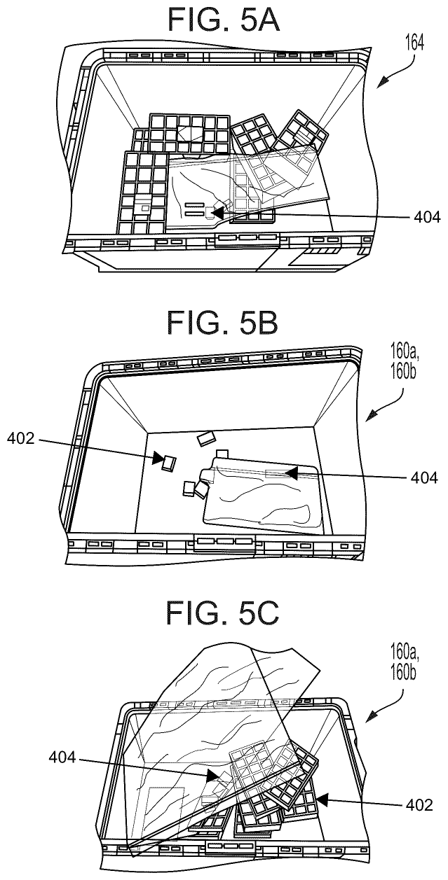

In step 312 of FIG. 3A, the order picker at the first picking station 604a picks an additional quantity of bottleneck units (SKU units) from the donor tote 160G and places these inventory units into a “set-aside” cubby 164. FIG. 4B illustrates an exemplary set-aside cubby 164 containing the additional bottleneck units that have been set aside. While FIG. 4B illustrates a plurality of bottleneck units 404 contained within the set-aside cubby 164, FIG. 5A illustrates the additional set-aside bottleneck units 404 placed into a plastic bag for placement in a multi-SKU tote (e.g., donor totes 160a, 160b). Other devices for separating the different bottleneck units from each other could also be used. The additional quantity of bottleneck units picked and placed into the set-aside cubby 164 may be equal to or less than the additional quantity of bottleneck units required to fill all orders requiring bottleneck units (of a given bottleneck SKU) for a given or predicted time period. As discussed herein, each picking station 604 can be used for distributing the golden SKU units of one or more golden totes 160G. Each set-aside cubby 164 can be used for storing one or more sets of golden SKU units (i.e., as discussed herein, each picking station 604 may utilize one or more set-aside cubby 164). As also discussed herein, multiple picking stations 604 can be used processing and distributing the golden SKU units of respective golden totes 160G. As discussed herein, the quantity of bottleneck SKU units that are placed into the set-aside cubby 164 may comprise either the quantity of bottleneck SKU units necessary to meet the remaining orders pending for the bottleneck SKU, or some other quantity of bottleneck SKU units such that a quantity of bottleneck SKU units remains in the golden tote 160G such that the golden tote 160G can be sent to another picking station 604 for further order fulfillment activities.

In step 314 of FIG. 3B, the bottleneck SKU units stored in the set-aside cubby 164 are opportunistically distributed to other donor totes and thereby making multi-SKU donor totes (e.g., donor totes 160a, 160b). For example, as illustrated in FIGS. 5B, 5C, and 6, the bottleneck SKU units 404 in the set-aside cubby 164 (e.g., stored in plastic bags or other devices to separate them) are distributed by adding them to another donor tote (e.g., donor tote 160a of FIG. 6) to create a multi-SKU donor tote 160a. Each distribution of golden SKU units from the set-aside cubby 164 will equal a quantity of golden SKU units required for at least one other order (thus, there is no conflict for the golden SKU units placed in the multi-SKU donor tote 160a). As illustrated in FIGS. 5B and 5C, the multi-SKU donor tote 160a includes two different inventory units (the original inventory SKU units 402 and the golden SKU units 404). Note that such a tote 160 can contain golden SKUs (e.g., gold SKU 404) or contain other SKUs in additional to other SKUs in the tote that are needed (i.e., a single SKU tote with eight (8) orders is just as “golden” as an 8-segment tote with each SKU having a single order fulfillment requirement). Thus, whenever an order picker has completed an order from a current donor tote 160 and there are no remaining picks in the order queue for that SKU, that donor tote 160 may be used as an opportunistic multi-SKU donor tote (e.g., donor tote 160a). That is, while the multi-SKU donor tote includes two SKUs, only the golden SKU units (e.g., gold SKU units 404) are associated with an order to fulfill (the original order(s) associated with the donor tote have already been fulfilled) such that the multi-SKU donor tote is able to function as a single-SKU tote for its allotment of golden SKU units. Note that the multi-SKU donor tote (160a, 160b) may be either delivered back into the storage area 602 or the multi-SKU donor tote may be delivered to a next (or another) picking station 604 (e.g., picking station 604b).

As also discussed herein, a multi-SKU donor tote may be opportunistically created out of any non-bottleneck donor tote 160 that has completed a current order (a donor pick) at picking station 604 and has a quantity of orders remaining (if any) below a threshold. While an example of less than one order remaining, i.e., no orders remaining, has been used herein, the threshold could be, for example, no more than two (2) orders remaining, or alternatively, no more than five (5) orders remaining. As discussed herein, when a multi-SKU donor tote 160a, 160b has been created, the picking station 604 will update the order fulfillment records at the order fulfillment system 100 and/or warehouse control system 101 with respect to the golden SKU units (e.g., gold SKU units 404) that have been placed into the multi-SKU donor tote 160a, 160b. For example, when the quantity of golden SKU units 404 placed into the multi-SKU donor tote 160a are associated with a particular fulfillment order, the order will be updated as to the location of the associated inventory items (i.e., the golden SKU units 404 for that order).

In step 316 of FIG. 3B, the quantity of set-aside bottleneck units (with the golden SKU) that are placed into a donor tote 160 to create a multi-SKU tote are marked or separated from the inventory units already in the donor tote 160. Note that the set-aside bottleneck units (e.g., bottleneck units 404) can be separated or marked by the way that the set-aside bottleneck units are placed or bundled to make them clearly separable from the other units (with another SKU) in the donor tote 160. As noted herein, one method of separating the inventory units (with the different SKUs) is to place the quantity of set-aside bottleneck units into a sealed plastic bag (see FIGS. 5B and 5C). Other methods for separating the inventory units may include tying the set-aside bottleneck SKU units together with a plastic strap or placing them in a “conspicuous placement” within the donor tote 160. FIGS. 5B and 5C illustrate exemplary methods for separating the inventory units (402, 404) by SKU.

As discussed herein, the donor totes 160 discussed so far have been unsegmented donor totes (e.g., unsegmented donor tote 702), such that the two different SKU units (402, 404) of the multi-SKU donor totes 160a, 160b can be comingled (see FIGS. 5B and 5C, and 7). In another embodiment, the donor totes 160 can be segmented (e.g., segmented donor tote 704), such that the two different SKU units of the multi-SKU donor totes 160a, 160b can be segregated into different compartments of the segmented donor totes 704 (see FIG. 7).

In step 318 of FIG. 3B, once the quantity of set-aside bottleneck SKU units has been distributed from the set-aside cubby 164, a next associated order can be released for picking. The picking station 604 (e.g., picking station 604b) receiving that next order can then access that multi-SKU donor tote 160a for order fulfillment (instead of requesting the donor tote 160G). In step 320 of FIG. 3B, a determination is made as to whether all the bottleneck units have been distributed from the set-aside cubby 164. If there are still bottleneck SKU units remaining in the set-aside cubby 164, then the method continues back to step 314 of FIG. 3B, and another distribution of the bottleneck units are passed from the set-aside cubby 164 to another donor tote 160 that has no more orders remaining for any remaining inventory units in the donor tote 160. For example, donor tote 160b is received at the picking station 604a and will receive a quantity of the remaining bottleneck SKU units after any required inventory units have been picked from the donor tote 160b by the picking station 604a. Thus, both multi-SKU donor totes 160a and 160b are opportunistically created at the picking station 604a and returned to inventory such that other picking stations 604b and 604n, respectively, have their orders fulfilled.

When all of the bottleneck SKU units have been distributed to create opportunistic multi-SKU donor totes (e.g., donor totes 160a, 160b), the method continues from step 320 of FIG. 3B and continues on to step 322 of FIG. 3B where for all remaining orders in the list of orders, the inventory units (in the remaining orders) are able to be picked from single SKU totes 160 and from multi-SKU totes (e.g., totes 160a, 160b) containing previous bottleneck SKU units. In other words, once all the set-aside bottleneck SKU units have been distributed to other donor totes (with a quantity of golden SKU units distributed for each pending order requiring the golden SKU units) to create the multi-SKU donor totes (e.g., donor totes 160a, 160b), the multi-SKU donor totes 160 are able to function as single SKU donor totes (with only the bottleneck SKU units still having pending orders), and with each of the multi-SKU donor totes 160a, 160b carrying a quantity of the golden SKU units required for a single order. Thus, the remaining orders requiring the golden SKU units will no longer be in contention for the required SKU units. Furthermore, by bagging, separating, or binding the distributed golden SKU units placed into multi-SKU donor totes 160a, 160b, the required golden SKU units are easily identified and found within the multi-SKU totes 160a, 160b.

The advantages of identifying those golden SKU units and their golden totes 160G, such that a predetermined quantity of the golden SKU units may be set aside and then opportunistically distributed to other donor totes 160 that have completed their last order (and are ready to return to the storage area 602), such that multi-SKU totes are created containing quantities of golden SKU units for single orders (and thus no conflict between orders), includes any of the following:
Efficiency is gained by removing order fulfillment bottlenecks. As discussed herein, bottlenecks due to the golden totes have a significant impact on order fulfillment throughput through starvation throughout the period of time and causes a large drop-off at the end of the period of time.
Maintaining high storage density without having to resort to splitting inventory units across stored donor totes (such splitting of bottleneck SKU inventory units into multiple stored donor totes reduces donor tote utilization or storage density and causes extra work).
The warehouse control system 101 or order fulfillment system 100 does not have to deal with golden tote contentions.
Opportunistic distribution at order fulfillment is a simple solution when compared to alternative solutions involving the splitting of golden SKU units into multiple donor totes at decant stations.
Opportunistic distribution at order fulfillment (as compared to conventional alternatives) provides a higher rate attainment, reduced costs, and increased customer satisfaction.
Requires less labor, fewer totes due to higher tote utilization, and resources due to the reduced time to complete the required work.

An order-fulfillment system 100, and/or a warehouse control system 101, and/or a warehouse execution system (WES) 104, which may also be referred to as a “controller” or “controller module,” is described with reference to the figures herein may generally comprise a processor configured to perform computations and control the functions of the system, including executing instructions included in computer code for the tools and programs capable of implementing methods for the management of a warehouse for order fulfillment, in accordance with some embodiments. The instructions of the computer code may be executed by the processor via a memory device or memory module. The computer code may include software or program instructions that may implement one or more algorithms for implementing one or more of the foregoing methods. The controller, the controller module, or the WES 104 that executes the computer code can be any processor such as a digital signal processor (DSP), a general purpose core processor, a graphical processing unit (GPU), a computer processing unit (CPU), a field programmable gate array (FPGA), an application specific integrated circuit (ASIC), a microprocessor, an AI/ML processing unit, a crypto-processor unit, a neural processing unit, a silicon-on-chip, a graphene-on-chip, a neural network-on-chip, a neuromorphic chip (NeuRRAM), a system on a chip (SoC), a system-in-package (SIP) configuration, either single-core or multi-core processor, or any suitable combination of components. A virtual processor can be formed as a portion of the controller, the controller module, or the order-fulfillment system 100, the warehouse control system 101, or the WES 104.

The memory device or memory module may include input data. The input data includes any inputs required by the computer code. The output device displays output from the computer code. A memory device may be used as a computer usable storage medium (or program storage device) having a computer-readable program embodied therein and/or having other data stored therein, wherein the computer-readable program comprises the computer code. Generally, a computer program product (or, alternatively, an article of manufacture) of the system may comprise said computer usable storage medium (or said program storage device).

As will be appreciated by one skilled in the art, the disclosure may be a computer program product. Any of the components of the embodiments of the disclosure can be deployed, managed, serviced, etc. by a service provider that offers to deploy or integrate computing infrastructure with respect to embodiments of the inventive concepts. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s), wherein the processor(s) carry out instructions contained in the computer code causing the computer system for generating a technique described with respect to embodiments. In another embodiment, an exemplary process for supporting computer infrastructure includes integrating computer-readable program code into a computer system including a processor.

Aspects of the disclosures are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative and exemplary embodiments of the present invention provide a method and system in which a donor tote (considered a “golden tote”) with units having a SKU that is required by multiple orders and thus results in an order fulfillment bottleneck (this SKU is considered a “golden SKU”) where any other picking station with an active order requiring the golden SKU inventory units is stalled as they wait for the golden tote with the golden SKU units to become available. An exemplary solution provides for the opportunistic creation of multi-SKU donor totes out of single-SKU donor totes at a picking station that had completed their last order requirement and were ready to return to a storage area. When the golden tote (with the golden SKU units) arrives at a first picking station, the picking station retrieves the quantity of golden SKU units required to complete its current order and then retrieves an additional quantity of golden SKU units equal to the total quantity of golden SKU units needed for all the remaining orders requiring the golden SKU inventory unit. These additional golden SKU units are placed into a “set-aside” cubby. From this set-aside cubby, the single-SKU donor totes are opportunistically provided with a quantity of the golden SKU units required by an order. The resulting multi-SKU donor tote will be either returned to the storage area awaiting the associated order, or if the associated order requiring the golden SKU units is active, the multi-SKU donor tote will be transported to the waiting picking station with the requesting order. Thus, the order fulfillment bottleneck can be mitigated by opportunistically distributing the golden SKU units across a plurality of other donor totes that have no other pending orders.

Changes and modifications in the specifically described embodiments can be carried out without departing from the principles of the present invention, which is intended to be limited only by the scope of the appended claims, as interpreted according to the principles of patent law including the doctrine of equivalents.

1. A material handling system for retrieving, transporting, and delivering donor totes for order fulfillment activities within a material handling facility, the material handling system comprising:
a plurality of picking stations, each configured for picking operations as part of order fulfillment activities in the material handling facility;
a storage area configured for storing inventory totes, each comprising one or more associated inventory items; and
a control system for controlling the order fulfillment activities within the material handling facility, wherein the control system is configured to identify an inventory tote as a multi-order tote containing inventory items required by a plurality of orders;
wherein a first picking station of the plurality of picking stations is configured to receive a first order and to request a first inventory tote comprising a plurality of first inventory items required by the first order, and wherein the first inventory tote is a multi-order tote;
wherein the first picking station is configured to retrieve a quantity of first inventory items from the first inventory tote as required by the first order, and wherein the first picking station is configured to retrieve a second quantity of first inventory items from the first inventory tote as defined by the control system, wherein the second quantity of first inventory items is the sum of first inventory items required by selected orders of the plurality of orders;
wherein the first picking station comprises a first cubby configured to hold the second quantity of first inventory items;
wherein the first picking station is configured to receive and process additional inventory totes comprising additional inventory items required by the first order or another order; and
wherein the first picking station is configured to retrieve a third quantity of first inventory items from the first cubby and place them into a selected second inventory tote of the additional inventory totes whose quantity of remaining orders to fulfill is below a threshold quantity of remaining orders, and wherein the third quantity of first inventory items is a quantity of first inventory items required by a second order of the selected orders.

2. The material handling system of claim 1, wherein the first picking station is configured to update the control system as to the identity of the second inventory tote and its association with the second order.

3. The material handling system of claim 2, wherein the control system is configured to direct the second inventory tote to a second picking station of the plurality of picking stations when the second picking station starts fulfilling the second order.

4. The material handling system of claim 3, wherein the control system is configured to direct the second inventory tote to the storage area to temporarily store the second inventory tote if the second picking station is not ready for the second inventory tote, and to direct the second inventory tote to the second picking station when the second picking station starts fulfilling the second order and requires the first inventory items in the second inventory tote.

5. The material handling system of claim 1, wherein the second inventory tote contains two different inventory items when the first inventory items are added to the second inventory tote.

6. The material handling system of claim 5, wherein the second inventory tote is configured as an unsegmented tote such that the two different inventory items are comingled.

7. The material handling system of claim 5, wherein the second inventory tote is configured as a segmented tote such that the first inventory items are segregated from the inventory items already stored in the second inventory tote.

8. The material handling system of claim 1 further comprising autonomous mobile robots (AMR) configured for retrieving inventory totes from the storage area and/or delivering the retrieved inventory totes to selected picking stations for order fulfillment activities.

9. The material handling system of claim 1, wherein the control system is operable to define a multi-order tote as comprising inventory SKU units that are required by a selected minimum number of orders to be fulfilled during a selected period of time.

10. The material handling system of claim 9, wherein the control system is operable to further define a multi-order tote according to dynamic or non-dynamic rules based on at least one of: order history, order forecasts, and supply chain information, and wherein parameters for the dynamic or non-dynamic rules are adjusted based upon the storage position of inventory SKU units, and the quantities of inventory SKU units and the quantities of orders requiring the inventory SKU units, and the duration that an order picker can remain idle waiting for a needed inventory SKU unit.

11. A method of order fulfillment bottleneck mitigation for a material handling system having one or more inventory totes comprising inventory items that are required by each of a plurality of orders to be fulfilled at a plurality of picking stations within a material handling facility, the method comprising:
receiving, at a first picking station, a first donor tote specific to a first order, wherein the first donor tote comprises first inventory items that are required by a plurality of other orders to be fulfilled at other picking stations;
retrieving from the first donor tote a first quantity of first inventory items required by the first order;
retrieving from the first donor tote a second quantity of first inventory items, wherein the second quantity is the sum of first inventory items required by selected orders of the plurality of other orders;
storing the second quantity of first inventory items in a temporary storage at the first picking station;
receiving at the first picking station, a second donor tote specific to the first order or another order;
retrieving from the second donor tote a quantity of inventory items required by the first order or the another order;
identifying that the second donor tote has a quantity of remaining orders to fulfill that is below a threshold quantity of remaining orders; and
retrieving a third quantity of first inventory items from the temporary storage and storing them in the second donor tote, and wherein the third quantity of first inventory items is a quantity of first inventory items required by a second order to be fulfilled at a second picking station.

12. The method of claim 11 further comprising updating a control system of the material handling facility as to the identity of the second inventory tote and its association with the second order.

13. The method of claim 12 further comprising directing the second inventory tote to the second picking station when the second picking station starts fulfilling the second order.

14. The method of claim 12 further comprising directing the second inventory tote to the storage area for temporary storage if the second picking station is not ready for the second inventory tote and directing the second inventory tote to the second picking station when the second picking station starts fulfilling the second order and requires the first inventory items in the second inventory tote.

15. The method of claim 11, wherein the second inventory tote contains two different inventory items when the first inventory items are added to the second inventory tote.

16. The method of claim 15, wherein the second inventory tote is configured as an unsegmented tote such that the two different inventory items are comingled.

17. The method of claim 15, wherein the second inventory tote is configured as a segmented tote such that the first inventory items are segregated from the inventory items already stored in the second inventory tote.

18. The method of claim 11, wherein the material handling facility comprises autonomous mobile robots (AMR) for retrieving inventory totes from the storage area and delivering the retrieved inventory totes to selected picking stations for order fulfillment activities.

19. The method of claim 11 further comprising identifying whether a donor tote is a multi-order tote as defined by a selected minimum number of orders to be fulfilled during a selected period of time, wherein the second quantity of first inventory items is retrieved from the first donor tote when the first donor tote is identified as a multi-order tote.

20. The method of claim 19, wherein identifying a donor tote as a multi-order tote is defined by dynamic or non-dynamic rules based on at least one of: order history, order forecasts, and supply chain information, and wherein parameters for the rules are adjusted based upon the storage position of inventory SKU units, and the quantities of inventory SKU units and the quantities of orders requiring the inventory SKU units, and the duration that an order picker can remain idle waiting for a needed inventory SKU unit.
